(19) United States
(12) Patent Application Publication
(10) Pub. No.: US 2017/0185003 A1
(43) Pub. Date: Jun. 29, 2017

(54) IMAGE FORMING APPARATUS

(71) Applicant: CANON KABUSHIKI KAISHA, Tokyo (JP)

(72) Inventor: Takateru Ohkubo, Susono-shi (JP)

(21) Appl. No.: 15/375,451

(22) Filed: Dec. 12, 2016

(30) Foreign Application Priority Data
Dec. 28, 2015 (JP) 2015-256688

(51) Int. Cl. G03G 15/16; G03G 15/00

(52) U.S. Cl. CPC G03G 15/161

(57) ABSTRACT

An image forming apparatus including a cleaning unit removably mountable to an apparatus main body under a state of being supported by a transfer unit, and movable with respect to the transfer unit in a longitudinal direction of a cleaning member under a state of not being mounted to the apparatus main body. The apparatus main body includes a frame unit portion configured to position a cartridge with respect to the apparatus main body in an axial direction of a photosensitive drum. The frame unit portion is configured to position the cleaning member with respect to the apparatus main body in the longitudinal direction under a state in which the transfer unit is mounted to the apparatus main body.

### BACKGROUND OF THE INVENTION

Field of the Invention

The present invention relates to an image forming apparatus, which includes a transfer unit including a belt configured to transfer a toner image from an image bearing member onto a transfer material and a cleaning unit configured to remove residual toner on the belt.

Description of the Related Art

In Japanese Patent No. 3815139, there is disclosed an image forming apparatus, which includes an image forming unit including an image bearing member configured to bear a toner image and a transfer unit including a belt configured to transfer the toner image from the image bearing member onto a transfer material. According to the configuration of Japanese Patent No. 3815139, residual toner on the belt is removed by a cleaning member.

In recent years, further downsizing is demanded of image forming apparatuses. Further downsizing is also demanded for a cleaning unit. In order to downsize the cleaning unit, the longitudinal width of a cleaning member needs to be reduced. However, the longitudinal width of the cleaning member needs to be larger than the longitudinal width of a developing member of an image forming unit. When this relationship is not satisfied, a toner image which cannot be removed may remain on a belt of a transfer unit and cause an image defect. Thus, in order to reduce the longitudinal width of the cleaning member of the cleaning unit, a relative positional relationship with the image forming unit needs to be determined with high accuracy.

However, according to Japanese Patent No. 3815139, the cleaning unit is positioned and fixed with respect to the transfer unit, and the image forming unit is fixed to an apparatus main body. Thus, a plurality of components are interposed between the cleaning member, which is a key component of the cleaning unit, and the image forming unit. That is, components such as the apparatus main body of the image forming apparatus, the transfer unit, and a casing of the cleaning unit are interposed, with the result that dimensional tolerances and mounting errors of those components in the longitudinal direction are imposed. Therefore, the longitudinal width of the cleaning member needs to be determined in consideration of those errors, and there is difficulty in reducing the longitudinal width of the cleaning member.

### SUMMARY OF THE INVENTION

According to the present invention there is provided an image forming apparatus including an apparatus main body, a cartridge being removably mountable to the apparatus main body and including a photosensitive drum configured to bear a toner image, a transfer unit being removably mountable to the apparatus main body and including a belt configured to transfer the toner image from the photosensitive drum onto a transfer material, a cleaning unit being removably mountable to the apparatus main body and including a cleaning member configured to remove residual toner on the belt, the cleaning unit supported by the transfer unit in a state where mounted to the apparatus main body and being movable with respect to the transfer unit in a longitudinal direction of the cleaning member in a state where not mounted to the apparatus main body, and a frame unit portion of the apparatus main body, which is configured to position the cartridge with respect to the apparatus main body in an axial direction of the photosensitive drum, wherein the frame unit portion is configured to position the cleaning member with respect to the apparatus main body in the longitudinal direction in a state where the transfer unit is mounted to the apparatus main body.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus according to a first embodiment of the present invention.

FIG. 2A and FIG. 2B are schematic perspective views of the image forming apparatus of FIG. 1.

FIG. 3A and FIG. 3B are plan views for illustrating a relationship of positioning portions for an image process unit, an intermediate transfer belt, and a belt cleaning device according to the first embodiment.

FIG. 4 is a plan view for illustrating the relationship of the positioning portions for the image process unit, the intermediate transfer belt, and the belt cleaning device according to the first embodiment more in detail.

FIG. 5A is a schematic perspective view of a transfer unit according to a second embodiment of the present invention.

FIG. 5B is an exploded perspective view of a cleaning device and an alignment roller.

FIG. 6 is a plan view for illustrating a relationship of positioning portions for an image process unit, an intermediate transfer belt, and a belt cleaning device according to the second embodiment more in detail.

FIG. 7 is a schematic view for illustrating a state of correcting a belt skew in the transfer unit according to the second embodiment.

### DESCRIPTION OF THE EMBODIMENTS

Now, the present invention is described in detail based on embodiments illustrated in the drawings.

### First Embodiment

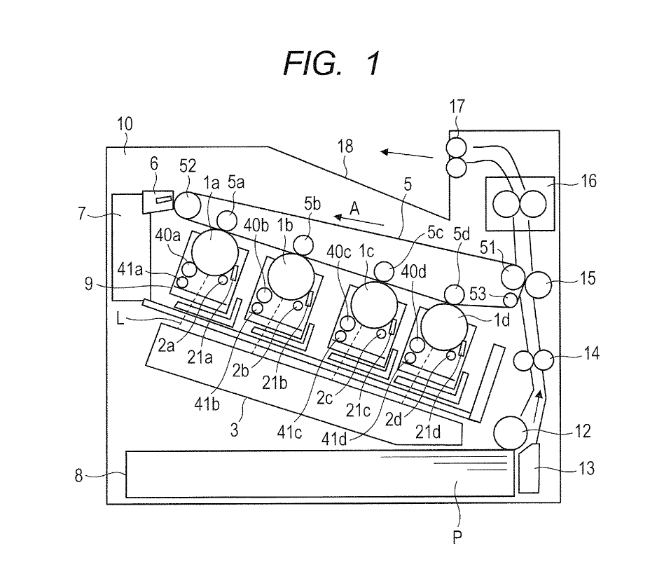

FIG. 1 is a schematic sectional view for illustrating a configuration of an image forming apparatus according to a first embodiment of the present invention. In the first embodiment, a color laser beam printer is described as an example of the image forming apparatus.

That is, the image forming apparatus includes a plurality of process cartridges 9 serving as image forming units, an intermediate transfer unit 5u including an intermediate transfer belt 5, and a cleaning unit 6 configured to remove residual toner on the intermediate transfer belt 5. The process cartridges 9 include photosensitive drums 1 serving as image bearing members configured to bear toner images. The intermediate transfer belt 5 of the intermediate transfer unit 5u is a belt configured to transfer the toner images from the photosensitive drums 1 onto a transfer material P.

In this embodiment, in order to form toner images of four different colors, four process cartridges 9 are arranged in parallel. The four process cartridges 9 have the same configuration. Thus, in the following description, the process cartridges and components thereof are denoted by reference symbols having suffixes a, b, c, and d added thereto.

The process cartridges 9a to 9d include developing rollers 40a to 40d serving as developing members configured to supply toner to the photosensitive drums 1a to 1d serving as image bearing members, and are arranged in parallel with each other at a center portion of an apparatus main body 10 in the right and left directions of FIG. 1.

The intermediate transfer belt 5 is an endless belt which is stretched around a pair of support rollers 51 and 52 located at both right and left ends. The intermediate transfer belt 5 is driven to rotate in the direction of the arrow A (counterclockwise direction in FIG. 1) under a state in which tension is applied by a tension roller 53. Although illustration is omitted in FIG. 1, the support rollers 51 and 52 and the tension roller 53 are arranged between a pair of side plates supporting the rollers. The intermediate transfer belt 5 is positioned above the photosensitive drums 1a to 1d of the process cartridges 9a to 9d. A running surface of the intermediate transfer belt 5 on a lower side is held in contact with respective circumferential surfaces of the photosensitive drums 1a to 1d.

Further, a secondary transfer roller 15 is arranged opposed to the support roller 51 on one side of the intermediate transfer belt 5 (right end in FIG. 1), and the cleaning unit 6 is arranged opposed to the support roller 52 on another end (left end in FIG. 1). For example, the support roller 51 opposed to the secondary transfer roller 15 is a driving roller, and the support roller 52 is a driven roller.

The cleaning unit 6 includes a cleaning brush 6br configured to remove residual toner on the intermediate transfer belt 5.

The toner images of different colors formed on the photosensitive drums 1a to 1d of the process cartridges 9a to 9d are primarily transferred onto the intermediate transfer belt 5 so as to be sequentially superimposed by primary transfer rollers 5a to 5d arranged in the intermediate transfer belt 5. After that, a toner image on the intermediate transfer belt 5 is secondarily transferred onto the transfer material P serving as a recording material by the secondary transfer roller 15 opposed to the support roller 51 on one side. With this, an output image is obtained.

Now, an image forming operation of the image forming apparatus of this embodiment is described more in detail.

When a print signal is transmitted from a controller (not shown) to drive the image forming apparatus, charging rollers 2a to 2d having voltage applied thereto uniformly charge the surfaces of the photosensitive drums 1a to 1d prior to latent image formation. A laser light L emitted from a laser scanner 3 is radiated to the charged surfaces of the photosensitive drums 1a to 1d. With this, electrostatic latent images for respective colors are formed. Then, developer application rollers 41a to 41d and the developing rollers 40a to 40d supply toner to the electrostatic latent images formed on the photosensitive drums 1a to 1d. With this, the electrostatic latent images are visualized as toner images.

The toner images of respective colors developed on the photosensitive drums 1a to 1d are primarily transferred in a sequential manner by the primary transfer rollers 5a to 5d, which are opposed to the photosensitive drums 1a to 1d over the intermediate transfer belt 5, onto the intermediate transfer belt 5 rotating in the direction of the arrow A. With this, the toner image is formed. The primary transfer of the toner images is performed through application of transfer voltage by the primary transfer rollers 5a to 5d.

Meanwhile, transfer materials P stacked and stored in a transfer material storage portion 8 arranged in a lower part of the apparatus main body 10 are separated into individual sheets and fed by a sheet feeding roller 12 and a separating portion 13. The transfer material P having been fed is conveyed to a position between the intermediate transfer belt 5 and the secondary transfer roller 15 at a predetermined timing by a registration roller pair 14. At this time, a secondary transfer voltage is applied to the secondary transfer roller 15, and the toner image preliminarily formed on the intermediate transfer belt 5 is secondarily transferred onto the transfer material P.

The transfer material P having the toner image secondarily transferred thereon is conveyed to a further upper side and passes through a fixing device 16, and the toner image on the transfer material P receives heat and pressure to be fixed. After that, the transfer material P is delivered by a delivery roller pair 17 to a delivery tray 18 arranged on an outer side of a casing of the apparatus main body 10.

Meanwhile, toner having remained on the surfaces of the photosensitive drums 1a to 1d after the transfer of the toner images is removed by cleaning blades 21a to 21d. Further, toner having remained on the intermediate transfer belt 5 after the secondary transfer to the transfer material P is controlled by the cleaning brush 6br, which is arranged in the cleaning unit 6, to have uniform toner polarity and caused to electrostatically adhere to the photosensitive drum 1a, thereby being removed by the cleaning blade 21a arranged in the process cartridge 9. The toner removed in the process cartridge 9 is connected to a waste toner conveyance passage (not shown) to pass therethrough and collected into a waste toner collection container 7.

The apparatus main body 10 has front, rear, right, and left surfaces, and includes, in the front surface, a front door Fd serving as a first opening and closing portion for allowing the process cartridges 9 to be removably mounted. Further, the apparatus main body 10 includes, in the right side surface which is substantially orthogonal to the front surface of the apparatus main body 10, a right door Rd serving as a second opening and closing portion for allowing the intermediate transfer unit 5u to be removably mounted.

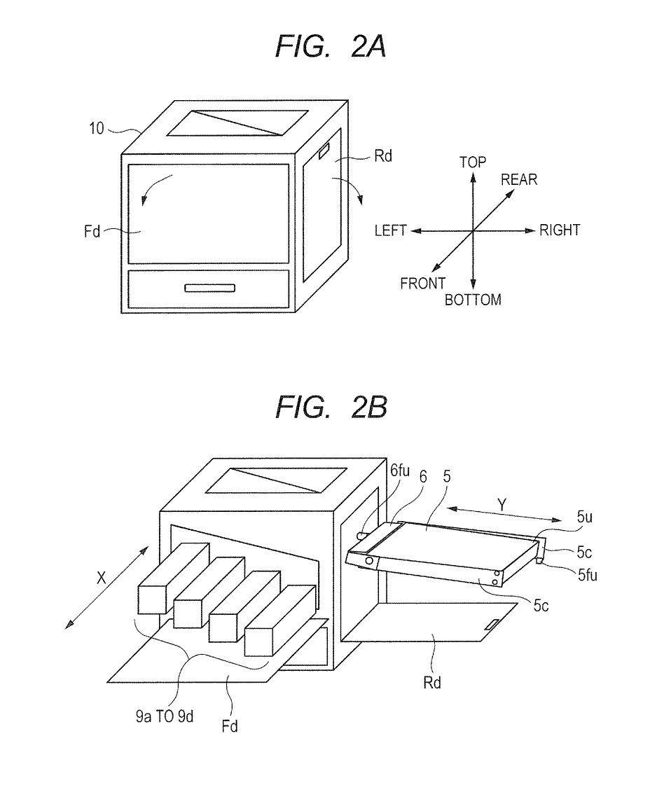

As illustrated in FIG. 2A and FIG. 2B, the process cartridges 9 can be removably mounted from the front side of the apparatus main body 10 in a first direction X parallel to a longitudinal direction of the developing rollers 40a to 40d by opening the front door Fd toward the front side of the apparatus main body 10. The first direction X is the longitudinal direction of each of the process cartridges 9, that is, the front and rear directions in FIG. 2A and FIG. 2B along axes of the photosensitive drums 1a to 1d and the developing rollers 40a to 40d. Meanwhile, the intermediate transfer unit 5u can be removably mounted together with the cleaning unit 6 from the right side in a second direction Y by opening the right door Rd, which is arranged on the right side surface oriented in a direction different from the front direction of the apparatus main body 10 by approximately 90°. The second direction Y is a direction orthogonal to the first direction X (front and rear directions) and along the running surface of the intermediate transfer belt 5. The second direction Y is slightly inclined with respect to the right and left directions.

Next, detailed description is made of a feature of the present invention, that is, a configuration of positioning the process cartridges 9, the intermediate transfer unit 5u, and the cleaning unit 6 with respect to the apparatus main body 10. As described above, the cleaning unit 6 is configured to remove the toner image having remained on the intermediate transfer belt 5 without being transferred.

Further, the cleaning unit 6 is supported by the intermediate transfer unit 5u, but is movable with respect to the intermediate transfer unit 5u in the longitudinal direction under a state of not being mounted to the apparatus main body 10.

With regard to the toner images to be transferred onto the intermediate transfer belt 5, toner is supplied by the developer application rollers 41a to 41d and the developing rollers 40a to 40d to the electrostatic latent images formed on the photosensitive drums 1a to 1d, and hence the toner images are visualized on the surfaces.

However, there is a case where toner borne on the developing rollers 40a to 40d is minutely transferred onto the photosensitive drums 1a to 1d by a force other than the electrostatic force, such as contact pressure, and it may be assumed that such toner is transferred onto the intermediate transfer belt 5. Therefore, the cleaning unit 6 needs to have a width which enables removal of such a minute amount of toner.

That is, in order to remove the toner having remained on the intermediate transfer belt 5 without being transferred, a width of the cleaning brush 6br of the cleaning unit 6 needs to be larger than the width of each of the developing rollers 40a to 40d. When the width of the developing rollers 40a to 40d is Ld, and the width of the cleaning brush 6br in the cleaning unit 6 is Lb, a relationship of Ld<Lb needs to be satisfied.

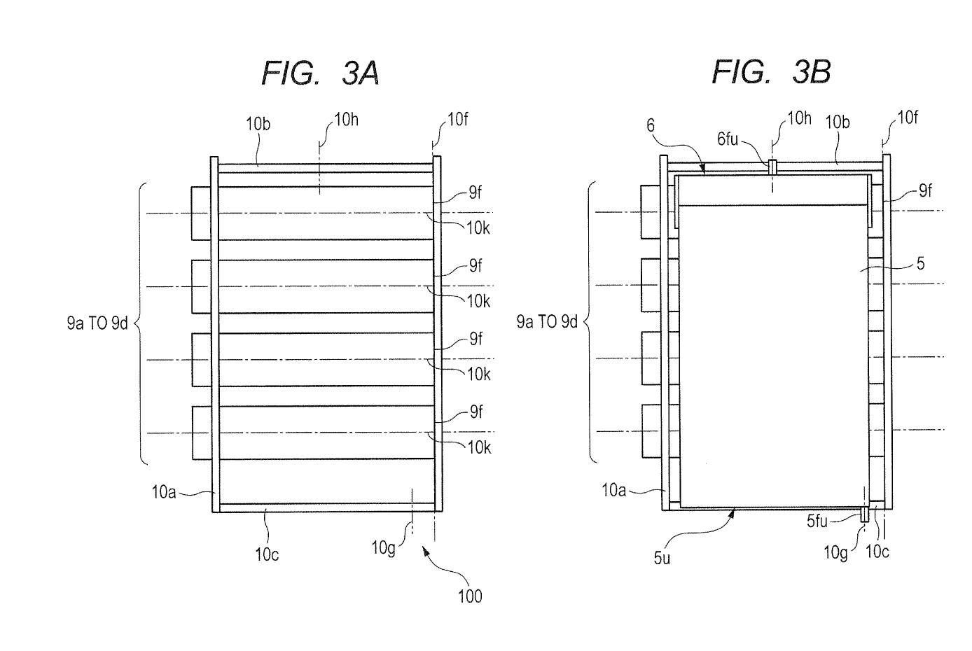

FIG. 3A and FIG. 3B are schematic views for illustrating a positional relationship between the process cartridges 9, which are to be mounted and positioned in the apparatus main body 10 illustrated in FIG. 1, and the cleaning unit 6 assembled to the intermediate transfer unit 5u. That is, FIG. 3A is a view for illustrating the process cartridges 9 mounted to the apparatus main body 10 as viewed from an upper side of FIG. 1. FIG. 3B is a view for illustrating a state in which the intermediate transfer unit 5u and the cleaning unit 6 are placed above the process cartridges 9 of FIG. 3A.

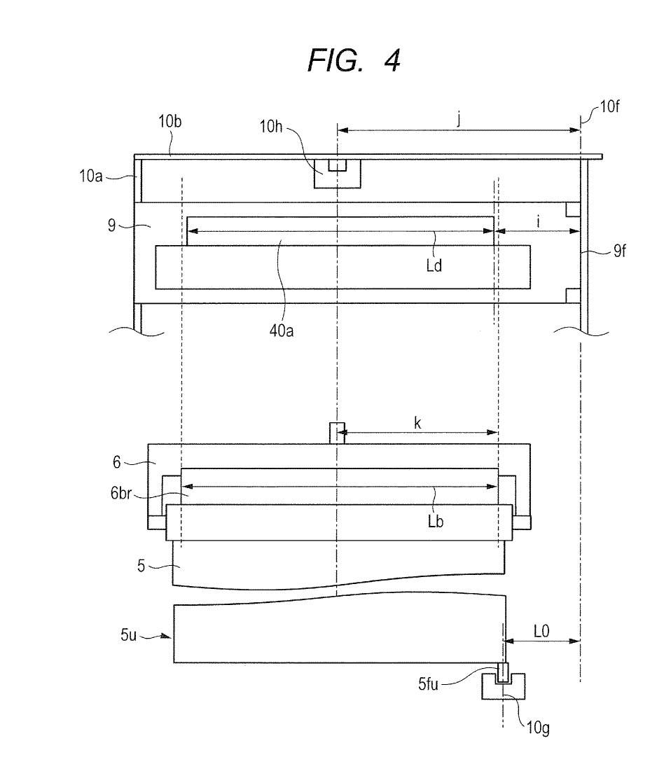

The cleaning unit 6 is assembled to the intermediate transfer unit 5u so as to be relatively movable in the longitudinal direction of the cleaning brush 6br. That is, as illustrated in FIG. 4, the cleaning unit 6 is arranged opposed to the support roller 52, which is configured to support the intermediate transfer belt 5, at one end side in the conveyance direction of the intermediate transfer belt 5. The cleaning unit 6 includes a casing 6c configured to retain the cleaning brush 6br, and both end portions of the casing 6c are supported coaxially with a rotary shaft of the opposed support roller 52 so as to be movable in the direction of the rotary shaft. Therefore, the cleaning unit 6 is roughly positioned in the longitudinal direction with respect to the intermediate transfer unit 5u when the cleaning unit 6 is present outside the apparatus main body 10.

Then, positioning of the cleaning brush 6br of the cleaning unit 6 in the longitudinal direction and positioning of the developing rollers 40a to 40d of the process cartridges 9 in the longitudinal direction are both performed with respect to the apparatus main body 10.

That is, the apparatus main body 10 includes a reference frame 10f configured to position the process cartridges 9 in the longitudinal direction through contact with rear end portions 9f of the process cartridges 9 on a far side in a mounting direction. On a left side frame 10b being a first frame orthogonal to the reference frame 10f, there is arranged a positioning portion 10h, which is a second positioning portion, configured to position the cleaning brush 6br of the cleaning unit 6 in the longitudinal direction.

Further, on a right side frame 10c being a second frame orthogonal to the reference frame 10f, there is arranged a positioning portion 10g configured to position the intermediate transfer unit 5u in a direction orthogonal to the reference frame 10f. With this, the intermediate transfer unit 5u and the cleaning unit 6 are positioned with respect to the reference frame 10f at different parts.

The reference frame 10f has a reference surface extending in a direction orthogonal to mounting and removing directions X of the process cartridges 9, that is, orthogonal to a roller shaft of the developing roller 40a. The process cartridges 9 pass through a front frame 10a, and the rear end portions 9f are brought into abutment against positioning portions 10k of the reference frame 10f. With this, the process cartridges 9 are positioned. The positioning portion 10h arranged on the left side frame 10b of the apparatus main body 10 is located at a center portion of the left side frame 10b with respect to the reference frame 10f as a reference. The cleaning unit 6 has a positioning protrusion 6fu which is a positioned portion to be engaged with the positioning portion 10h in a mounting direction Y of the intermediate transfer unit 5u. The positioning protrusion 6fu is arranged on the casing 6c configured to retain the cleaning brush 6br.

The positioning portion 10g arranged on the right side frame 10c of the apparatus main body 10 is arranged on one edge side of the intermediate transfer belt 5 with respect to the reference frame 10f as a reference. The intermediate transfer unit 5u has a positioning protrusion 5fu which is a positioned portion to be engaged with the positioning portion 10g in a mounting direction of the intermediate transfer unit 5u. The positioning protrusion 5fu is arranged on side plates 5c and 5c configured to support both ends of each of the support rollers 51 and 52 for the intermediate transfer belt 5 of the intermediate transfer unit 5u. Herein, the reference frame 10f, the right side frame 10c, and the left side frame 10b construct a frame unit portion 100.

With this, the support rollers 51 and 52 configured to support the intermediate transfer belt 5 of the intermediate transfer unit 5u are positioned in the longitudinal direction (roller shaft direction).

In FIG. 3A and FIG. 3B, the positioning portions 10g and 10h are illustrated only with the one-dot chain lines at positioning positions from the reference frame 10f serving as a reference. As illustrated in FIG. 4, the positioning portions 10g and 10h are formed into shapes having grooves which allow the positioning protrusions 5fu and 6fu to be fitted, respectively, to position the cleaning brush 6br and the support rollers 51 and 52 for the intermediate transfer belt 5 in the longitudinal direction.

The positioning protrusions 6fu and 5fu, and the positioning portions 10h and 10g arranged on the left side frame 10b and the right side frame 10c of the apparatus main body 10 are arranged opposed to each other in the mounting and removing directions of the intermediate transfer unit 5u and the belt cleaning device. The positioning protrusions 5fu and 6fu arranged on the belt cleaning device and the intermediate transfer unit 5u are capable to be inserted and removed with respect to the positioning portions 10h and 10g on the apparatus main body 10 side in the mounting and removing directions of the intermediate transfer unit 5u.

Thus, concurrently with the operation of mounting and removing the intermediate transfer unit 5u together with the cleaning unit 6 to the apparatus main body in the second direction, the positioning protrusions 6fu and 5fu and the positioning portions 10h and 10g are engaged and disengaged with each other.

FIG. 4 is a schematic view for illustrating a positional relationship between the developing roller 40a, which is the developing member arranged in one process cartridge 9, and the cleaning brush roller 6br arranged in the cleaning unit 6 for the intermediate transfer belt 5.

As illustrated in FIG. 4, the longitudinal width Ld of the developing roller 40a arranged in the process cartridge 9 and the longitudinal width Lb of the cleaning brush 6br arranged in the cleaning unit 6 are determined regardless of the position of the intermediate transfer unit 5u.

That is, it is only necessary that Lb be set to a minimum width within the range satisfying Ld<Lb in consideration of dimensional tolerances in inter-component dimensions i, j, and k in FIG. 4, which may occur in the process cartridge 9 and the cleaning unit 6. With this, downsizing of the cleaning brush 6br can be achieved.

Herein, the dimension i is a dimension from a far end wall of the process cartridge 9, which is brought into abutment against the reference frame 10f as a reference, to a far end of the developing roller 40a. The dimension j is a dimension from the reference frame 10f as a reference to a center of the groove of the positioning portion 10h for the cleaning unit 6. The dimension k is a dimension from a center of the positioning protrusion 6fu of the cleaning unit 6 to one end of the cleaning brush 6br.

Meanwhile, the intermediate transfer unit 5u is positioned through abutment of the positioning protrusion 5fu, which is arranged in the intermediate transfer unit 5u, against the positioning portion 10g arranged at a position of a distance L0 with respect to the reference frame 10f as a reference.

As described above, the cleaning unit 6 including the cleaning brush 6br is roughly positioned with respect to the intermediate transfer unit 5u in the longitudinal direction when the cleaning unit 6 is present outside the apparatus main body 10.

When the cleaning unit 6 is mounted to the apparatus main body 10, the cleaning brush 6br is directly positioned with respect to the apparatus main body 10 in the longitudinal direction without intermediation of the intermediate transfer belt 5, and hence is positioned with high accuracy with respect to the process cartridge 9 positioned with respect to the apparatus main body 10. With this, the developing roller 40 of the process cartridge 9 and the cleaning brush 6br of the cleaning unit 6 can be mounted with minimized tolerances and mounting errors of the positioning portions in the longitudinal direction.

With this, further downsizing of the cleaning brush 6br and the cleaning unit 6 can be achieved. As a result, space saving of the apparatus main body and downsizing of process parts can be achieved, thereby being capable of providing a small and inexpensive image forming apparatus to a user.

### Second Embodiment

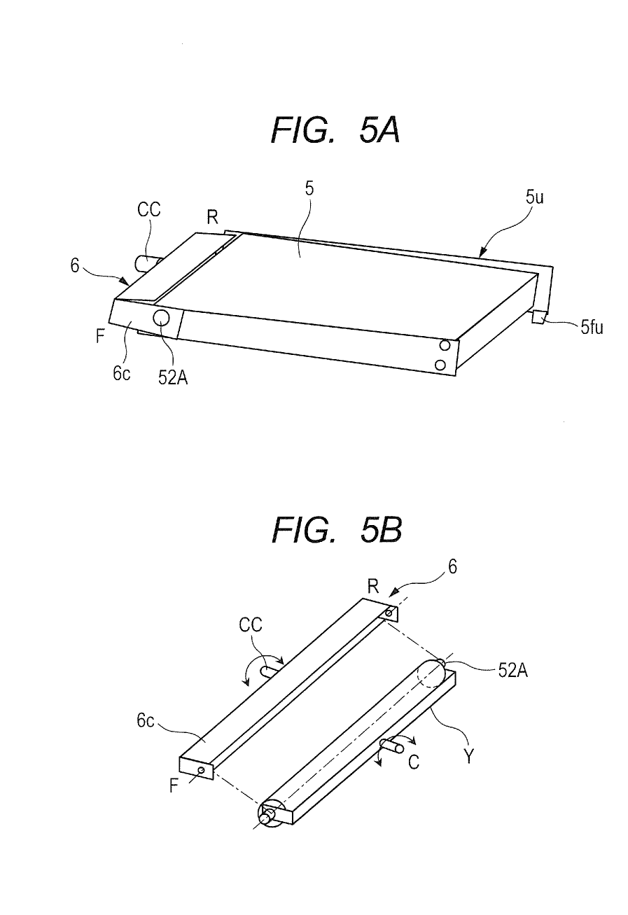

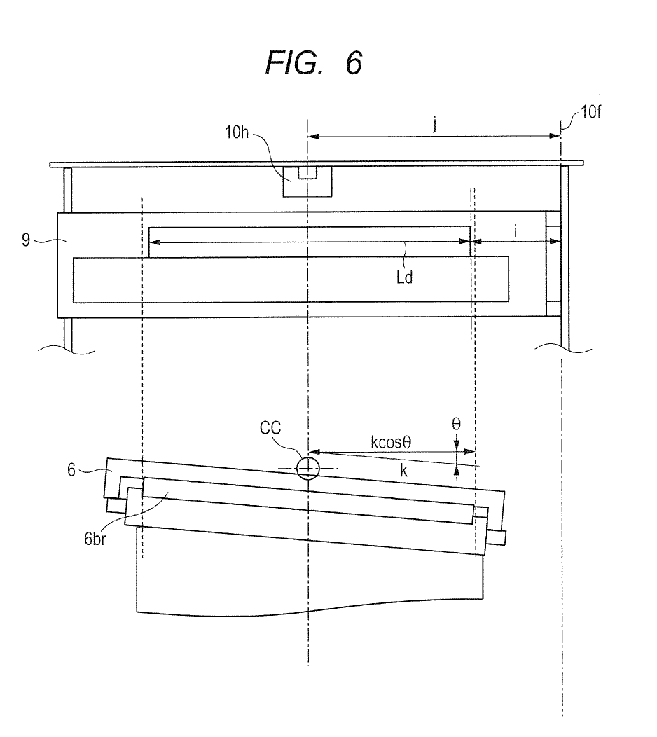

Next, description is made of an image forming apparatus according to a second embodiment of the present invention with reference to FIG. 5A, FIG. 5B, and FIG. 6.

In the second embodiment, the support roller 52, which is arranged at a position opposed to the cleaning unit 6 to stretch the intermediate transfer belt 5, is an alignment roller 52A which can tilt with respect to the support roller 51 positioned at another end of the intermediate transfer unit 5u. The alignment roller 52A has a configuration in which a roller shaft thereof can tilt about a rotary center shaft C as a rotary fulcrum located in a midway of a roller shaft direction. The alignment roller 52A has a belt skew correcting function. The second embodiment is different from the above-mentioned first embodiment in that the cleaning unit 6 is mounted to the alignment roller 52A.

In the second embodiment, even when the alignment roller 52A is displaced in a tilting direction, fluctuation during the correction is not hindered. Further, positioning is performed with respect to the developing roller 40 so as to have a minimum relative displacement in the longitudinal direction, as in the first embodiment. That is, the cleaning brush 6br is positioned with respect to the apparatus main body 10 regardless of the position of the intermediate transfer belt 5. With this, the longitudinal width of the cleaning brush 6br, which is a key component for cleaning, is set to a minimum width in consideration of maximum displacement or the tolerances and mounting errors, thereby being capable of preventing occurrence of cleaning failure and achieving downsizing of the cleaning brush 6br.

In the following description, only the matters different from the first embodiment are mainly described. The components which are the same as those of the first embodiment are denoted by the same reference symbols, and description thereof is omitted.

First, the alignment roller 52A is described.

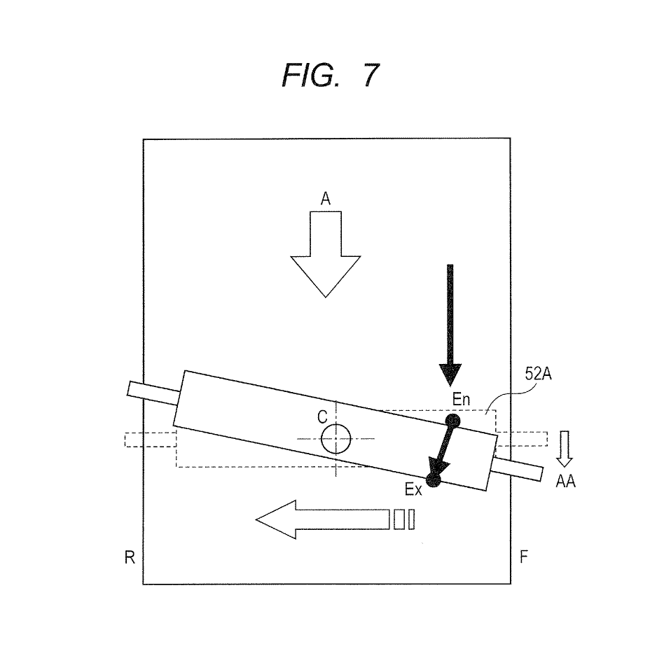

A rotary shaft of the alignment roller 52A is rotatably supported by a retaining member Y. The retaining member Y is retained with respect to a bearing portion (not shown), which is arranged in the apparatus main body, so as to be rotatable about the rotary center shaft C as a rotary fulcrum with respect to the intermediate transfer unit 5u. Further, at both end portions of the alignment roller 52A, there are arranged belt skew detection elements (not shown) such as edge sensors. When the intermediate transfer belt 5 skews toward the F-side (front side) as illustrated in FIG. 7 under certain conditions, a cam (not shown) is driven to cause the alignment roller 52A to turn in the direction AA about the rotary center shaft C.

With this, when the intermediate transfer belt 5 runs in the direction A, the alignment roller 52A moved in the direction AA causes the intermediate transfer belt 5 to run as follows. First, the intermediate transfer belt 5 advances with a certain phase En, and thereafter moves in a circumferential direction on the alignment roller 52A. Then, the intermediate transfer belt 5 passes through a phase Ex displaced toward the R-side (rear surface side) and is delivered.

As a result, when a shaft end of the alignment roller 52A is moved toward downstream in the direction AA with respect to a belt running direction, the intermediate transfer belt 5 skews toward the R-side (rear surface side). On the contrary, when the belt is moved toward upstream, the belt can skew to the F-side (front surface side). With this, even when the intermediate transfer belt 5 skews in one direction, highly tolerant lifetime can be achieved without excessive stress through abutment of the end portion against another member.

Next, the cleaning unit 6 is described.

The cleaning unit 6 is arranged at a position opposed to the alignment roller 52A. The cleaning unit 6 is supported substantially coaxially with the rotary shaft of the opposed alignment roller 52A so as to be movable in the longitudinal direction of the cleaning brush 6br. When the intermediate transfer unit 5u is mounted to the apparatus main body 10, the cleaning unit 6 is restricted in position with respect to the rotary shaft direction of the alignment roller 52A by a positioning shaft CC as a positioned portion, which is to be engaged with the positioning portion 10h of the apparatus main body 10. Herein, the positioning portion 10h is a first positioning portion. The rotary shaft direction of the alignment roller 52A is parallel to the longitudinal direction of the cleaning brush 6br.

The positioning portion 10h, as in the positioning portion 10h illustrated in FIG. 4, has a groove to which the positioning shaft CC is to be fitted. The positioning portion 10h is configured to position the cleaning unit 6 in the longitudinal direction and support the cleaning unit 6 so that the cleaning unit 6 is rotatable about the positioning shaft CC.

With this, even when the alignment roller 52A is tilted to adjust the alignment, the cleaning unit 6 does not hinder the movement of the alignment roller 52A.

Further, the positioning shaft CC is rotatably supported by the positioning portion 10h. Thus, the cleaning unit 6 turns about the positioning shaft CC with respect to the apparatus main body 10 in accordance with the tilt of the alignment roller 52A. Thus, it is only necessary that Lb be set to a minimum width within the range satisfying Ld<Lb in consideration of k cos θ for a case of actuation by a maximum displacement angle θ, in addition to dimensional tolerances in inter-component dimensions i, j, and k in FIG. 6, which may occur in the process cartridge 9 and the cleaning unit 6. With this, downsizing of the cleaning brush 6br can be achieved.

With the configuration described above, space saving of the apparatus main body and downsizing of the process parts can be achieved, thereby being capable of providing a small, inexpensive, and highly tolerant image forming apparatus to the user.

In the first embodiment and the second embodiment described above, there is exemplified the mode in which the cleaning brush is arranged as the cleaning member in the cleaning unit 6. However, the cleaning member is not limited to the cleaning brush. Even when a cleaning roller capable of controlling toner polarity or a cleaning blade capable of mechanically scraping off toner is used in place of the cleaning brush, the minimum width can be achieved with a similar configuration.

Further, in each of the embodiments described above, the intermediate transfer unit is described as an example of the transfer unit. However, the present invention is also applicable to a conveyance transfer unit including a conveyance belt configured to convey a transfer material. That is, the present invention is applicable to a transfer unit including a belt configured to transfer a toner image from the photosensitive drum 1 serving as an image bearing member onto the transfer material P.

Further, in each of the embodiments described above, the process cartridges 9 serving as the image forming units are directly positioned with respect to the apparatus main body 10. However, the positioning may also be performed through positioning of the developing rollers 40, which are arranged in the process cartridges 9, in the longitudinal direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-256688, filed Dec. 28, 2015, which is hereby incorporated by reference herein in its entirety.

What is claimed is:

1. An image forming apparatus, comprising:
an apparatus main body;
a cartridge being removably mountable to the apparatus main body and including a photosensitive drum configured to bear a toner image;
a transfer unit being removably mountable to the apparatus main body and including a belt configured to transfer the toner image from the photosensitive drum onto a transfer material;
a cleaning unit being removably mountable to the apparatus main body and including a cleaning member configured to remove residual toner on the belt, the cleaning unit supported by the transfer unit in a state where mounted to the apparatus main body and being movable with respect to the transfer unit in a longitudinal direction of the cleaning member in a state where not mounted to the apparatus main body; and
a frame unit portion of the apparatus main body, which is configured to position the cartridge with respect to the apparatus main body in an axial direction of the photosensitive drum,
wherein the frame unit portion is configured to position the cleaning member with respect to the apparatus main body in the longitudinal direction in a state where the transfer unit is mounted to the apparatus main body.

2. An image forming apparatus according to claim 1, wherein the frame unit portion includes a first positioning portion which is engagable with a positioned portion of the transfer unit, and the cleaning member is positioned with respect to the apparatus main body through engagement of the positioned portion of the transfer unit with the first positioning portion.

3. An image forming apparatus according to claim 2, wherein the cartridge is removably insertable into the apparatus main body in a first direction parallel to the axial direction of the photosensitive drum.

4. An image forming apparatus according to claim 3, wherein the transfer unit is removably insertable, together with the cleaning unit, into the apparatus main body in a second direction orthogonal to the first direction and along a running surface of the belt.

5. An image forming apparatus according to claim 4, wherein the frame unit portion includes:
a reference frame configured to position the cartridge in the longitudinal direction through abutment of a rear end portion of the cartridge on a far side in a mounting direction; and
a first frame orthogonal to the reference frame as a reference, the first frame being configured to position the cleaning unit with respect to the apparatus main body in the longitudinal direction.

6. An image forming apparatus according to claim 3, wherein the frame unit portion includes a second frame orthogonal to the reference frame, and the second frame includes a positioning portion configured to position the transfer unit in a direction orthogonal to the reference frame.

7. An image forming apparatus according to claim 6, wherein the transfer unit and the cleaning unit include positioned portions configured to be engaged with the positioning portions arranged in the first frame and the second frame in the mounting direction of the transfer unit.

8. An image forming apparatus according to claim 2, wherein the positioned portion of the transfer unit is inserted and removed with respect to the first positioning portion of the transfer unit.

9. An image forming apparatus according to claim 8, wherein the positioned portion of the transfer unit comprises a positioning shaft, and the transfer unit is configured to rotatably support the cleaning unit in a state in which the positioning shaft is engaged with the first positioning portion.

10. An image forming apparatus according to claim 7,
wherein the cleaning unit is arranged opposed to a support roller, which is configured to support the belt, at one end side of a conveyance direction of the belt, and
wherein the cleaning unit is supported coaxially with a rotary shaft of the support roller opposed thereto so as to be movable in a rotary shaft direction, and is restricted in position with respect to the rotary shaft direction of the support roller by the positioned portion engaged with the positioning portion of the apparatus main body when the transfer unit is mounted to the apparatus main body.

11. An image forming apparatus according to claim 7, further comprising a support roller opposed to the cleaning unit, which is capable of tilting with respect to another support roller in a direction of tilting a rotary shaft about a rotary fulcrum positioned in a midway of a roller shaft direction as a rotary center,
wherein the positioning portion configured to position the cleaning unit with respect to the apparatus main body is arranged substantially coaxially with the rotary shaft as the rotary fulcrum.

12. An image forming apparatus according to claim 1, wherein the cartridge includes a developing roller configured to supply toner to the photosensitive drum, and positioning of the cartridge with respect to the apparatus main body in the longitudinal direction is performed through positioning of the developing roller in the longitudinal direction.

13. An image forming apparatus according to claim 1, wherein the transfer unit includes an intermediate transfer belt as the belt.
